(19) United States
(12) Patent Application Publication
(10) Pub. No.: US 2007/0131860 A1
(43) Pub. Date: Jun. 14, 2007

(54) Quadrupole mass spectrometry chemical sensor technology

(76) Inventor: John Lawrence Freeouf, Portland, OR (US)

Correspondence Address: Alvin J. Riddles;44 Lake Drive South, P.O. Box 34 Candlewood, Isle, New Fairfield, CT, 06812-0034, US

(21) Appl. No.: 11/301,324

(22) Filed: Dec. 12, 2005

(51) Int. Cl. H01J 49/00; B01D 59/44

(52) U.S. Cl. 250/292; 250/281

(57) ABSTRACT

In the invention, the principles of the conversion of signals representing the existence and quantity of chemical traces in an ambient gas into quantification and qualification signals through quadropole mass filtration are achieved, in a controlled pressure environment, wherein the ambient gas is ionized, processed in a mass filter where in the presence of fields the ions of the chemical traces in the ambient gas are separated and removed for detection and quantification. The mass filter is photolithographically replicated on the surface of a wafer type body and the mass filtration occurs in a spatial volume formed within the wafer type body.

### FIELD OF THE INVENTION

The invention is in the field of the sensing of the presence and quantity of chemicals in an ambient gas such as the atmosphere and in particular to chemical detection technology employing the quadrupole mass spectrometer.

### BACKGROUND AND RELATION TO THE PRIOR ART

Quadrupole mass spectrometer apparatus, for use in the sensing of the presence and quantity of chemicals in a gaseous ambient, would include as a main element, a quadrupole mass filter structural assembly capable of atomic selection based on atomic particle mass, together with means for introducing ionized ambient gas into the quadrupole mass filter, means for detecting specific ions in the ionized gas and means for detecting quantity and quality attributes of those selected ions.

In the quadrupole mass filter structure, in a body member, between upper and lower plane surface members, there is an enclosed spatial volume within which there is located a configuration of four parallel, equidistant as in a bolt circle, rod shaped conductor members, each of which extends between the upper and lower plane surfaces. An ion path opening and exit, are provided, positioned, centered into and centered exiting from the upper and lower planes within the spatial volume containing the rod shaped conductor member configuration.

In operation; to the quadrupole mass spectrometer device, there is supplied to individual diagonally positioned pairs of the rod members, combined, direct current (DC) levels and phased radiofrequency (RF) signals; such that, for a fixed value of RF and DC voltages, input ion energy, conductor dimensions and frequency: there is produced a cylindrical field in the spatial volume. The cylindrical field affects the ability of certain ions, arriving through the ion path opening, that have a specific ratio of charge to mass, that in turn is identifiable with certain chemicals, to traverse the spatial volume and be processed in a detection capability beyond the ion path exit.

There has been some effort in the art to adapt the mass spectrometer technology to miniaturization.

In the work of Taylor et al in Proc. S.P.I.E. 4036, 187 (2000) a quadrupole mass spectrometer is described wherein electrochemical etching is employed to fabricate grooves in the surfaces of two silicon wafers using the crystallographic orientation for position, so that rods positioned in the grooves then provide control of a spacing dimension between the wafers.

In the work of Chutjian et al, of which U.S. Pat. Nos. 6,469,299 and 6,871,671 are exemplary, the rod and groove technique is photolithographically expanded to an array of about 16, then assembled with other structures made separately, but requiring individual alignment.

Such an array requires a separate conductor for each rod which limits size (i.e. number of elements) in the array.

In the work of Friedman et al in J. Vac. Sci. Technol. 17, 2300 (1999) a mass spectrometer is described which relies on the time of flight of ions in identifying certain ones. Miniaturization of time of flight type systems imposes extra difficulties in that the short flight path that is involved will in turn require either a short time scale or a very low ion energy.

In the work of Kornienko et al. as described in Rapid Commun. Mass Spectrum 13, 50.(1999) a different type of arrangement called an ion trap mass is employed in identifying certain ions.

In the work of Saini et al as described in U.S. Pat. No. 6,956,219 an ion focusing structure is assembled involving nanomanipulation in adhesively aligning pieces on a substrate.

In the various technologies being studied, although there has been progress in performance, sensitivity and reliability, compromises have had to be made in shapes, and further, the various portions of any quadrupole mass spectrometer system, when made, using the techniques presently employed in the art, will have to have parts that are independently fabricated and then assembled into a system.

There is a growing need in the art for technical progress that can provide an ability to depart from the present practice of building one by one assemblies and will permit the building of arrays of mass spectrometers all with the required performance, sensitivity, and reliability; through a series of common steps.

### SUMMARY OF THE INVENTION

In the invention, the principles of the conversion of signals representing the existence and quantity of chemical traces in an ambient gas into quantification and qualification signals through quadropole mass filtration are achieved through an apparatus and processing in which, in a controlled pressure environment, there is a new quadropole mass filter and in a new juxtaposed

In the overall spectrometer assembly, in a first stage, the incoming sample of the ambient is ionized and passed in a centered ion path between the ionization stage and a juxtaposed quadrupole mass filter stage wherein ions are separated by mass and ejected into a juxtaposed detection stage in which signals of content and quantity are developed.

### BRIEF DESCRIPTION OF THE DRAWINGS

FIG. 1 is a cross sectional depiction of the relative superpositioned relationship of the ionization region, the quadrupole mass filter region and the detection region of the chemical sensor of the invention.

FIG. 2 is a perspective depiction where the layer 17 of FIG. 1 has been removed for visibility; wherein there is shown the four equidistant, as in a bolt circle type rod configuration, of the mass filter along the cross section line A-A in FIG. 1 also illustrating the enclosed spatial volume.

FIG. 3 is a perspective schematic depiction of the ion selection operation within the hyperbolic fields associated with the four rod configuration of the mass filter.

### DESCRIPTION OF THE INVENTION

In the ionization stage the ambient gas is ionized, by being subjected for example to a high energy electron concentration followed by being extracted and drawn out through and into an ion path and into the quadrupole mass filter stage.

In the new quadrupole mass filter stage at site locations between the parallel surfaces of a field is produced in the spatial volume. The ionized ambient gas; in which the ions are at fixed energy that must be controlled by applied potentials, is focused into the ion path at the opening in the top one of the parallel wafer surfaces through the hyperbolic cylindrical field in the spatial volume and out the ion path exit in the bottom one of the parallel surfaces. The ions in the ionized ambient gas that have a specific ratio of charge to ion mass are selected in passing through the field in the spatial volume and exit in the ion path into the detector stage.

It should be noted that the principles of the new mass filter of this invention are also adaptable for ion separation where an independent ion source is provided.

In the detector stage, a correlation and conversion is made to develop signals related to specific chemicals.

### BRIEF DESCRIPTION OF THE DRAWINGS

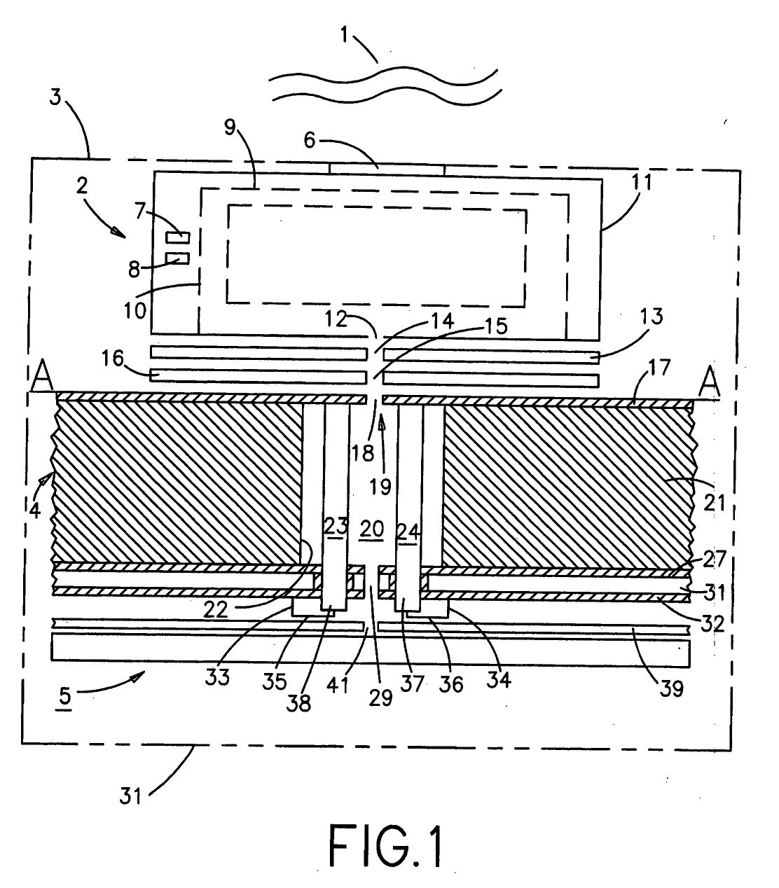

FIG. 1 is a cross sectional depiction of the relative superpositioned relationship of the ionization region, the quadrupole mass filter region and the detection region of the chemical sensor of the invention.

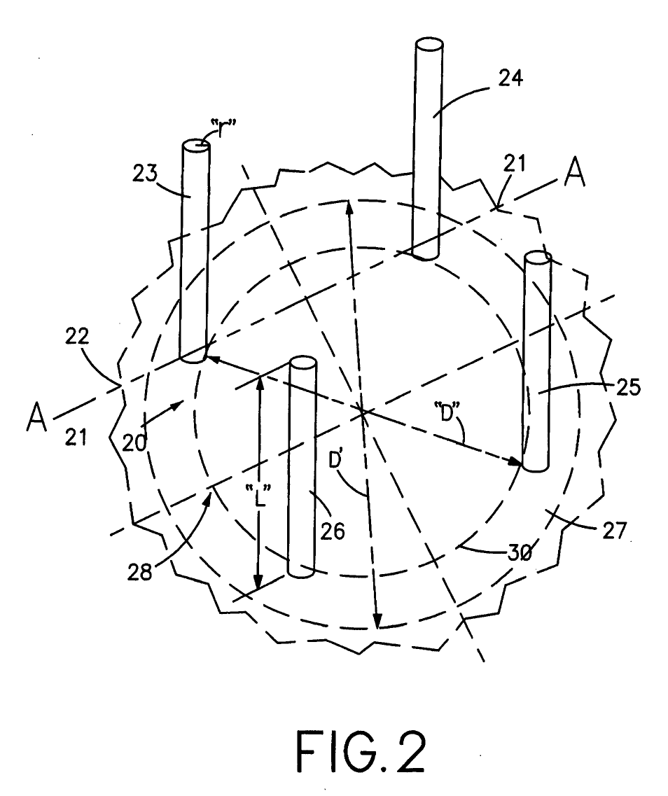

FIG. 2 is a perspective depiction where the layer 17 of FIG. 1 has been removed for visibility; wherein there is shown the four equidistant, as in a bolt circle type rod configuration, of the mass filter along the cross section line A-A in FIG. 1 also illustrating the enclosed spatial volume.

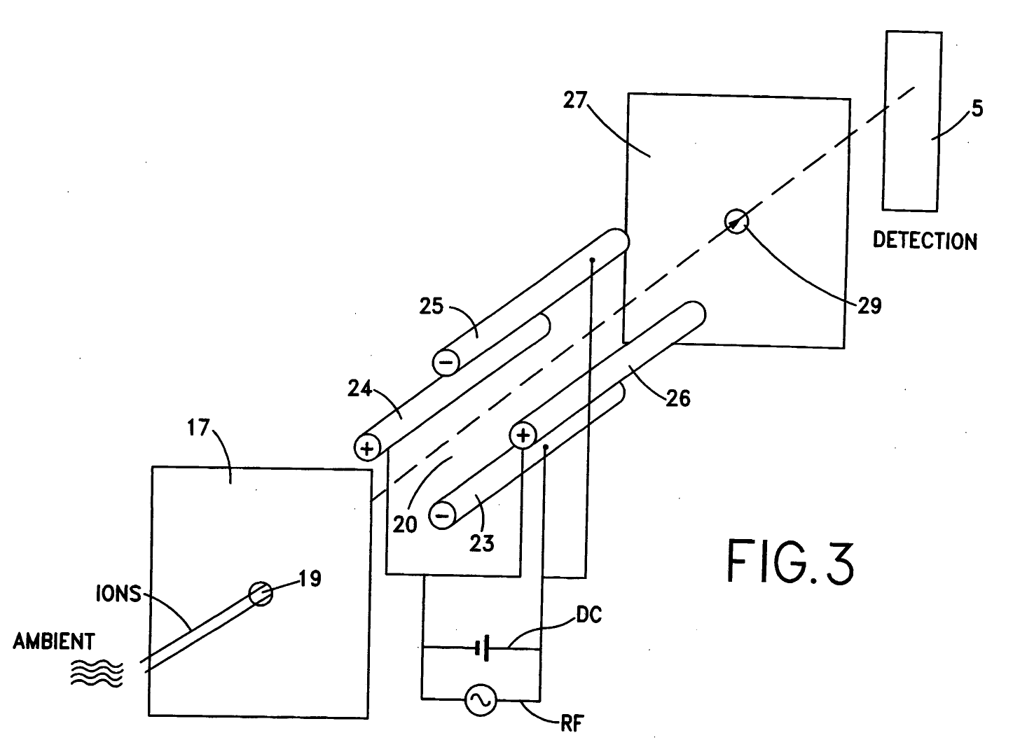

FIG. 3 is a perspective schematic depiction of the ion selection operation within the hyperbolic fields associated with the four rod configuration of the mass filter.

### DESCRIPTION OF THE INVENTION

In the efforts to satisfy the expanding need for chemical sensors to be used in fields ranging from detection of leaks, to the presence of agents in an ambient, originating from natural or industrial processes; it has become recognized that substantial advantages in sensitivity and physical size could be achieved through the use of the capabilities of quadrupole mass spectrometry. The quadrupole mass spectrometry technology has been extensively discussed in the art of which Peter H. Dawson, Quadrupole Mass Spectroscopy and its Applications (Elsevier, N.Y. (1976), pp 9-11). and R. A. Syms et al in the publication IEEE Transactions on Electron Devices 45, 2304(1998), are examples, but the hurdles in implementation of the technology are formidable.

Among those hurdles are the facts that the quadrupole mass filter achieves deflection based on the ratio of effective ion electric charge to ion mass so that the ambient gas sample being analyzed must be handled in such a way that the operations of ion identification, extraction and electron multiplication, do not overwhelm any signal being developed; many of the actual dimensions are so small that fabrication and assembly require special skills and dimensions must be carefully controlled in both horizontal and vertical directions.

In accordance with this invention a structural and processing approach is advanced through the use of planar fabrication technology as used in the semiconductor industry which provides the benefits of precise dimension control in both horizontal and vertical directions as well as the ability to employ photo replication in arrays.

The approach is illustrated through FIGS. 1-3 wherein in FIG. 1 there is shown a cross sectional depictional view of the superimposed, in a controlled pressure region 3, there is an ionization 2, mass filter 4 and detection 5 regions of the quadropole mass spectrometry chemical sensor of the invention wherein a chemical ingredient in an ambient gas 1 is ionized in the ionization region 2, the ions are then moved into the mass filter region 4, positioned contiguous to the ionization region 2. In the mass filter region 4, the ions are subjected to a hyperbolic field in an enclosed spatial volume 20. The mass filter region 4 may be made up of one or more wafers, wherein certain ions having a specific ratio of charge to mass that is identifiable with particular chemicals, pass through the region and exit into a contiguously positioned detection region 5 for analysis and identification.

In FIG. 1 the ionization 2 and detection 5 regions are positioned on both sides of a bulk portion of the mass filter region 4. The bulk portion of region 4 which may be made of one or more wafers, only one of which is shown and which serves the many functions of: providing physical support, establishing rod length related dimensions, housing the quadrupole mass filter spatial enclosure 20, housing the rod configuration of elements 23-26 of which 23 and 24 are shown, and, housing the hyperbolic cylindrical field.

In the ionization region 2, the ambient gas 1 is introduced through an inlet 6. There is provided a separate electron source 7 providing electrons through an accelerator 8 into an ion cage 9 within an electron repellant screen 10 all mounted in a housing 11. In general, where the electrons are of low energy, negative electrons are captured, and where the electrons are sufficiently energetic so that electrons are scattered out of the molecule, positive ions occur. The ions are then extracted from the housing 11 into an ion path opening 12, by applying a positive charge to an extractor electrode 13 also having an ion path hole 14, and thereafter the ions being at a specific energy are focused through another ion path hole 15 in an appropriately charged focusing electrode 16. The extractor 13 and focusing 16 electrodes, are deposited metal layers, such as aluminium with deposited insulating coatings such as aluminum oxide positioned on an insulating surface 17 of the wafer bulk member 4. All deposited layers are aligned with a central ion path hole so that the openings 12, 14, 15 and 18 form an enclosed ion path 19 extending from the ionization region 2 into the mass filter region 4.

In fabrication, the insulating material of the bulk portion of the mass filter region 4 would most likely be silicon because it is such a thoroughly studied and used material. The insulating coatings, such as 17, would likely be silicon oxide.

The quadrupole mass filter in the filter region 4 achieves the filtering through interaction of both structural elements and fields.

Referring to FIGS. 1,2 and 3, wherein like reference numerals are used for the same item in each figure, in FIG. 1 there is shown a cross section of the parts in superimposed position; in FIG. 2 there is a perspective schematic depiction, with the layer 17 removed for visibility of the other parts, of the intersection of the hyperbolic fields within the enclosed spatial volume 20 and the four rod configuration showing the line A-A which in turn shows the location of the cross section of FIG. 1; and, in FIG. 3 where there is shown a perspective schematic depiction of the ion selection operation within the hyperbolic field associated with the four rod configuration of the mass filter.

In accordance with this, quadropole mass spectrometry chemical sensor invention, the novel structural and processing approach, is built around the use of an insulating material bulk member for the filter housing, which may be one or more wafers, that have two essentially parallel top and bottom surfaces, between which the rods of the four equidistant rod configuration pass. The distance between the surfaces provides a benchmark around which length of rod dimensions are achieved and the area enclosed by the rod configuration serves as a guideline for photo lithographic repetition in the plane of the upper or top surface, of the bulk or wafer member. This facilitates the use of planar fabrication technology as used in the semiconductor industry which in turn provides the benefits of precise dimension control in both horizontal and vertical directions as well as the ability to employ photo lithographic replication in arrays.

The dimensions involved are quite small and there is a large aspect ratio. The vertical distance between the surfaces is much greater than the horizontal distances between rods.

The dimensions cause constraints to be encountered in relating the design of the mass filter to it's operation. In the previously referred to reference, R. A. Syms et al, in IEEE Transactions on Electron Devices 45, (1998) at page 2304, there is discussion of the optimum radius (dimension “r” in FIG. 2) of the rod members 23-26. In particular the optimum radius (r) of the rod members 23-26 is 1.148 Ro where 2 Ro is the separation between two diagonally positioned rods (Dimension “D” in FIG. 2), and where the rods have a circular cross section. This relationship varies on the order of one percent where the surroundings are altered to include a possible ground plate member, not shown, that may become too close to the rods.

In accordance with the work of Boumsellek et al. in Am. Soc. For Mass Spec. 12, 633 (2001), the maximum operating pressure, in the controlled environment 3, would be inversely proportional to the length of the mass filter (Dimension L in FIG. 2) and the sensitivity of the mass filter would be proportional to (Ro) (Ro/L).

From this it would appear that the mass resolution achievable would be in accordance with Equation 1, and that the maximum RF voltage required would be in accordance with Equation 2.
m=3.854×10V axial/(fL) Equation 1
where
V axial is the energy of the ions in the mass filter (in eV),
f is the frequency of the RF signal applied to the mass filter as shown in FIG. 3, and
L is dimension L in FIG. 2.
   V max=14.46×10m max f Ro; Equation 2
where m max is the largest mass number (in AMU) to be studied,
An example design suitable for scanning 0-100 AMU sets f=72×10s, Ro=6 m, L=1000 m, V axial=5EV and m max=100 AMU.
These choices lead to R=6.89 m, Vmax=2.7V, and m=3.7 AMU.

For the length of 1 mm in this example design, the maximum operating pressure in the controlled environment in 3 in FIG. 1 should be 0.1 torr.

Assuming, as an example, a sensor that is built in silicon and occupies about a cubic centimeter in volume. The length of the rods 23-26 will affect the traverse rate of the ions and hence the quantity of ions that are selected in the filter.

The work of Ferran et al, titled “Effects of quadrupole analysers for RGA”, published in Journal Vac Sci Tech. A-Vacuum, Surfaces, and Films, page 1258 (1996) provides a good perspective in selection for another and further exemplary design, as follows.

The length of the rods 23-26 labelled distance “L” in FIG. 2, between the surfaces 17 and 27 in FIG. 1, would be about 500 micrometers. The radius of an individual rod, labelled dimension “r” in FIG. 2, would be about 4.56 micrometers. The diameter of a circle, labelled element 30, that tangentially touches all four of the rods 23-26 in the example configuration, labelled dimension “D” in FIG. 2 would be about 8 micrometers.

Continuing to refer to FIG. 2, the quadrupole mass filter operates through approximating hyperbolic cylindrical fields in a spatial volume enclosure 20 bounded by edges 21 and 22 achieved by the positioning of four parallel, equidistant as in a bolt circle, rod elements 23,24,25 and 26, of radius “r”, of which 25 and 26 are not visible in the FIG. 1 cross sectional view whereas 23 and 24 are visible.

The rod members are positioned equidistantly apart and tangentially around the dotted circle labelled element 30 the diameter of which is shown as dimension D, and is expressed as in equation 3.
D=2Ro Equation 3
There are also some practical considerations in establishing the dimensions of the open spatial volume 20. The control of field perturbations caused by charge or voltage distributions around the surrounding walls make it desirable to extend the circle outside the rods 23,24,25 and 26.

The extended outer boundary is shown as element 30′. Re is the radius of the cylinder.

The outer boundary diameter D′ can be expressed as in Equation 4.
D′≧2Ro+2Re+2Re Equation 4

Each of rod members 23,24,25 and 26 have a length “L” and extend between the upper surface 17 of the bulk member 4, that is visible in FIG. 1, removed and not visible in FIG. 2, and is depicted in FIG. 3, and the lower surface 27 of the bulk member 4.

Referring to FIG. 3, opposing voltages of direct current (DC) signals and phased radio frequency (RF) signals, are applied on diagonally positioned rod pairs 23,24 and 25,26 such that, for a fixed value of RF, DC, input ion energy and conductor dimensions, a hyperbolic cylindrical field is produced in the spatial volume labelled element 20 in each of FIGS. 1, 2 and 3.

A field 28 radiates from the rods 23-26 and intersects tangentially with each rod as shown in FIG. 2, with the diagonal distance of the rod configuration labelled dimension D,D′.

The field affects the ability of ions, with a specific ratio of charge to mass, to traverse the spatial volume 20 between entrance ion opening 19 in surface 17 in FIGS. 1 and 3 and exiting from ion opening 29 in FIGS. 1 and 3; and to thereby produce a detected signal; rather than being rejected, through collision with the rods 23-26.

There is some flexibility in providing the wiring to the rods that produces the DC and RF fields, in that, referring to FIG. 1, the wiring could be placed directly on the surfaces 17 and 27 of the bulk member 4 or it could be placed on a supporting member 31. The use of a separate wiring supporting member such as element 31 has the advantage of avoiding conflicts in more complex wiring situations.

Referring to FIG. 3 the wiring is depicted. The wiring connects DC and RF sources to diagonally positioned, + and − labelled rods 24 and 26 and 23 and 25.

Referring to FIG. 1, wiring to the rods 23 and 24 can be accomplished by using the supporting member 31. The member 31 would be of a material such as silicon with high electrical resistivity and with an etch resistant coating 32 such as silicon oxide. The rods 23 and 24 are extended with members 37 and 38 through member 31, and coating 32 to wiring conductors 33 and 34 that have been deposited on the lower surface of the coated 32 member 31. A single connection 35,36 is then made to each rod 23,24. through members 37 and 38 with a single heat cycle assembly operation that fuses the connections of the rods to the members that extend through the wiring supporting member 31. A major advantage with this type of planar wiring construction is that there need be only one connection per rod type; in an array. This is of importance in large array development. If the array is large, and separate contact and connection lines are required for each rod in the array as does the Chutjian reference, then array size will be limited by the availability of area for the contact pads and the connection lines. Where instead, only one or a few contact pads per bias type there becomes permitted a single contact pad and a single connection wire to contact multiple rods, the chip area then can be primarily devoted to active parts of the mass filter. Fewer pads and lines are needed. This is similar to the approach taken in large scale integration of semiconductor chips, where there are vastly more internal devices than input and output contact pads.

The rods 23-26 are formed, as done in standard semiconductor practice, for the example material silicon, by etching through a shaped hole in a photoresist on the surfaces 17 and 27 all the way through the wafer 4, followed by coating the inside of the hole and plating. In the technology there is theoretically considered to be an advantage to have the rod footprint to have a shape resembling a hyperbola, a heretofore considered to be a difficult task. In photolithography any shape can be patterned by the mask used in the photolithography.

The material of wafer 4 that had occupied the spatial volume 20 in FIG. 1, within the dotted line 30 in FIG. 2, and between the rods in FIG. 3 as final step is etched out through the openings 19 and 29, or through the sides of the wafer 4, when they are sufficiently proximate.

A focusing capability is provided by a simple deposited metal, such as an aluminum, about 1 micrometer thick layer 39, with a center hole 40, that when electrically connected can focus the selected ions emanating from exit 29 into the detection region 5 at opening 41. The exit 29 is about 1-22% of the total layer area.

Returning to FIG. 1; the selected ions that have traversed the fields of the quadrupole mass filtration stage 3 are delivered to the detection region 5 where the output signal is to be developed. The output arrangements useable in region 5 can, within the principles of the invention, extend, from a single wire fed into a picoammeter which is the simplest, to multistage arrangements involving electron amplification employing such devices as microchannel plates, channeltrons, and spiraltrons, wherein an output signal developed from the ions in the detector 5 that is then compared with a stored signal of a specific chemical. Detection of such chemicals as O, Cl, NH, I, HO as examples may be accomplished. The system signal level is improved and significantly enhanced by operation wherein collisions with atoms in the ambient is prevented. This is achieved as illustrated by element 3 in FIG. 1 with the dotted controlled environment enclosure, serving as a housing, surrounding all regions 1-5 and letting in only the ambient through the inlet 6 while maintaining an evacuated, typically less than about 0.1 Torr. environment by using a standard commercial pump, not shown.

In fabrication the general approach is to use planar type processing techniques similar to the techniques developed in the semiconductor industry. Using this quadropole mass filter, as an example, in such planar type processing fabrication there will be needs for:
the ability to achieve a pattern of rods of well defined position, orientation, size and shape;
the ability to get DC and RF voltages to each rod,
the ability to open an enclosed spatial enclosure surrounding the rods to permit the ions to pass through the mass filter, and,
the ability to provide centered apertures at the top and bottom of the mass filter to guide ambient bourne chemical ions in the mass filter.

Referring to FIGS. 1, 2, and 3 together, the fabrication process would involve the steps of:
applying a protective coating layer of silicon oxide on the top 17 and bottom 21 surfaces of a bulk member, a silicon wafer 4,
lithographically patterning the ends of rods 23-26 into the top 17 silicon oxide layer leaving the remainder of the layer 17 covered by photoresist,
etching holes for each of the 23-26 rod pattern entirely through the silicon wafer 4, using an etchant that etches the silicon wafer 4 but not the silicon oxide protective layer,
replicate the 23-26 rod pattern into the bottom layer 21 surface using an etchant that etches the silicon oxide but not the silicon wafer,
bonding the patterned silicon oxide coated silicon wafer 4 with the etched hole pattern through it to a metal plate to serve as an electroplating electrode,
immersing the patterned silicon oxide coated silicon wafer 4 with the etched 23-26 hole pattern through it together with the metal plate as an electrode in a plating bath for a metal that will resist etching by an agent that will etch silicon, such as gold,
conduct an electroplating seeding operation that deposits electroplating seeding material on the walls of the rod 23-26 holes entirely through the wafer, and,
fill the rod 23-26 hole openings with electroplated gold.

The result is the selective deposition of gold on seeded material that is accessed only through the holes in the wafer 4 in the form of the 23-26 rod configuration.

The ion entrance and exit holes 19 and 29 are then patterned and etched open with an etch that etches the metal of the layers 17 and 27 such as gold but not the silicon wafer 4.

The metal wiring, symbolized by elements 33 and 34, that provide the DC and RF connections shown in FIG. 3 to the rods 23 and 24, is deposited on surface 32 by standard vapor deposition, and again patterned by standard photolithography.

There is a final operation of etching away of the portion of the wafer 4 out to the dotted line 30′ in FIG. 2 that occupied the enclosed spatial volume 20. This is done through the ion entrance and exit openings 19 and 29 or through the side of the wafer where available, using an etchant that etches the silicon wafer but not the aluminum, gold, insulating, or other films required for the final structure. Structural accommodations may have to be made in the mass filter for strength and rigidity.

There are some operational, environmental and housing considerations. Structurally the ideal situation would be to provide all features on one semiconductor chip, inside a vacuum system housing. Some accommodations may be required in the form of standard insulation constraints for high voltage and RF.

Where an active vacuum pump is desired, the vacuum pump controller will likely be a separate item of electronics. A major consideration is that it is likely to consume 10-100 watts of power depending on the details of the pump and it's requirements of operation. Specialized control, but standard for that art, will be needed. An alternative is to use a getter or sorption pump in portable operation. Such a pump requires reactivation after pumping to it's capacity but requires little power or control electronics during the portable operation.

Another component likely to require special consideration would be the picoammeter in the detection region where used. Some isolation may be needed due to noise pickup, from for example, the RF source and connections.

What has been described is the technology involved in the adaption of the technology principles of quadrupole mass spectronomy in providing a unique mass filter of the invention that takes advantage of the dimensional precision and repeatability achievable with the mask controlled deposition, etching, erosion, seeding and plating techniques of planar type processing.

What is claimed is:

1. Quadrupole mass spectrometer apparatus comprising in combination:
a body member having first and second parallel plane surfaces,
a spatial volume positioned and enclosed within said body member,
a configuration of four, parallel, equidistant around a circle, rod shaped, specific length, conductor members, located within said spatial volume, each said rod shaped conductor member extending between said first and second parallel plane surfaces,
a first ion path opening through said first plane surface member extending into the center of said configuration of conductor members,
a second ion path opening through said second plane surface member exiting at the center of said configuration of conductor members,
means establishing in said spatial volume, in diagonally located pairs of said four rod members, a combined field, containing a direct current (DC) level and a phased radio frequency (RF) signal;
means introducing into said first ion path opening an ionized gaseous ambient containing at least one desired chemical, and,
means detecting at said second ion path opening the presence of ions of said desired chemical.

2. The apparatus of claim 1 wherein: said means introducing into said first ion path opening, an ionized gaseous ambient containing at least one desired chemical, is an ionization region, in which said gaseous ambient is subjected to a high electron concentration.

3. The apparatus of claim 2 wherein: said means detecting at said second ion path opening the presence of ions of said desired chemical is a picoammeter.

4. The apparatus of claim 2 wherein: said means detecting at said second ion path opening the presence of ions of said desired chemical is a comparison with a stored signal of the to be detected chemical.

5. Apparatus for chemical analysis of a gaseous ambient comprising in combination:
within a quadrupole mass spectrometer controlled environment,
an ionization region, said ionization region being capable of performing the operations of receiving said gaseous ambient through an inlet centered in an input surface area, subjecting said gaseous ambient to a high electron concentration, whereby the gas of
said gaseous ambient is ionized, and,
delivering said ionized gas to a mass filter ion path opening,
a mass filter region, having a centered filter ion path opening, said mass filter region being capable of performing the operations of
separating, based on particular atomic mass, selected ions received at said ion path opening, and delivering said selected ions to a centered ion path exit
said separating operation including;
a filter body member having entrance and exit parallel surfaces through which said centered entrance and exit ion paths pass,
said filter body member further having a spatial volume positioned and enclosed within said entrance and exit parallel surfaces,
said filter body member further having, centered around said entrance and exit ion path openings within said spatial volume, a configuration of four, parallel, equidistant around a circle, rod shaped, specific length, conductor members, each said rod shaped conductor member extending between said entrance and exit parallel surfaces,
means establishing in said spatial volume, in diagonally located pairs of said rod shaped conductor members, a combined field, containing a direct current (DC) level and a phased radio frequency (RF) signal; and,
a detection region operable to perform the operations of at least one of:
a magnitude measurement of a signal derived from said selected ions delivered from said exit of said mass filter, and,
a comparison of a known chemical signal with a signal derived from said selected ions delivered from said exit of said mass filter.

6. The apparatus for chemical analysis of claim 5 wherein said quadrupole mass spectrometer controlled environment is a vacuum with an operating pressure of about 0.1 Torr.

7. The apparatus for chemical analysis of claim 5 wherein ion movement is controlled by a charged metal layer surrounding an ion path hole where said metal layer covers up to about 22% of said layer area.

8. The apparatus for chemical analysis of claim 5 wherein said ionization region and said detection regions are positioned with said mass filter region between them.

9. The apparatus for chemical analysis of claim 5 wherein wiring for the means establishing said combined field is positioned on an insulating member with portions of each said rod shaped conductor member extending there through.

10. The fabrication of a configuration of conductor members that pass through a bulk body member of insulating material having first and second essentially parallel surfaces comprising in combination the steps of:
applying a protective coating on said body member of a material that is resistant to attack by an acid that would attack the material of said body member,
applying lithographically a pattern of the ends of said conductor member configuration on said first surface of said body member leaving the remainder of said first surface covered by photoresist,
etching a hole for each conductor of said conductor member configuration entirely through said body member, using an etchant that etches the material of said body member but not said protective coating material,
replicate said pattern for each conductor of said conductor member configuration into said second surface of said body member, using an etchant that etches said protective coating material but not the material of said body member,
bonding said second surface of said body member with said conductor pattern to a metal plate to serve as an electroplating electrode,
immersing said body member with said metal plate in a plating bath for a metal that will resist etching by an agent that will etch the material of said body silicon, such as gold,
conduct an electroplating seeding operation that deposits electroplating seeding material on the walls of said etched holes for said configuration of conductor members, that extend entirely through said body member, and,
fill said seeded holes with electroplated metal.

11. A fabrication process for quadrupole mass spectrometry apparatus of the type having in a controlled pressure environment ionization of the ambient gas, processing in a mass filter where in the presence of fields the ions are diverted for quantity and quality type detection of chemicals, comprising the following steps:
apply a protective coating layer of silicon oxide on the top and bottom surfaces of a silicon body member,
lithographically pattern openings in a layer of photoresist conforming to the pattern of the ends of the rods in the rod configuration into the top said silicon oxide layer leaving the remainder of the said top silicon oxide layer covered by photoresist,
etching the holes for each of the rods entirely through the silicon body member, using an etchant that will etch the silicon body member but will not etch the silicon oxide protective layer,
replicate the configuration rod pattern into the bottom surface layer of the silicon body member using an etchant that etches the silicon oxide but not the silicon,
bond, the patterned silicon oxide coated silicon body member with the etched hole pattern of the rod configuration through it, to a metal plate that is to serve as an electroplating electrode,
immerse the patterned silicon oxide coated silicon body member with the etched hole pattern through it, together with the metal plate serving as an electrode, in a plating bath for gold that will resist etching by an agent that will etch silicon,
conduct an electroplating seeding operation that deposits gold electroplating seeding material on the walls of the rod configuration holes that have been etched entirely through the silicon body,
replicate the configuration rod pattern into the bottom surface layer of the body member using an etchant that etches the silicon oxide but not the silicon,
bond, the patterned silicon oxide coated silicon body member with the etched hole pattern of the rod configuration through it, to a metal plate that is to serve as an electroplating electrode,
immerse the patterned silicon oxide coated silicon body member with the etched hole pattern through it, together with the metal plate serving as an electrode, in a plating bath for gold that will resist etching by an agent that will etch silicon,
conduct an electroplating seeding operation that deposits gold electroplating seeding material on the walls of the rod configuration holes entirely through the body member, for a duration sufficient to fill the rod configuration hole openings with electroplated gold, whereby there is selective deposition of gold on seeded material accessed only through the rod configuration holes,
pattern and etch open the ion entrance and exit holes in the body member surfaces with an etch that etches the metal on those surfaces but not the body member,
deposit on an aligned insulator member with rod configuration holes, the metal wiring, patterned by standard photolithography and deposition of conductors that will serve for t the DC and RF field connections to an aligned insulator member, and,
etch away the silicon material occupying the spatial volume through the entrance and exit holes in the body member using an etchant that etches the silicon body member but not the aluminum, gold, or insulating silicon oxide.
